(19) United States
(12) Patent Application Publication
(10) Pub. No.: US 2019/0331222 A1
(43) Pub. Date: Oct. 31, 2019

(54) PISTON WITH OPTIMIZED OIL RING NEGATION

(71) Applicant: Federal-Mogul LLC, Southfield, MI (US)

(72) Inventors: Miguel Azevedo, Trion, GA (US); Gregory Salenbien, Britton, MI (US)

(21) Appl. No.: 15/963,838

(22) Filed: Apr. 26, 2018

(51) Int. Cl. F16J 1/09; F01P 3/22; F02F 3/00; F16J 1/08

(52) U.S. Cl. CPC F16J 1/09; F01P 3/22; F02F 2003/0007; F16J 1/08; F02F 3/003

(57) ABSTRACT

A piston formed of steel and/or cast iron for a heavy-duty diesel engine which includes an oil belt for controlling an oil film and thus achieving reduced oil consumption and carbon build-up is provided. The piston includes an uppercrown portion presenting a combustion surface, a ring belt depending from the combustion surface, pin bosses depending from the ring belt, and skirt panels depending from the ring belt and located diametrically opposite one another. The ring belt includes two ring grooves preferentially but accommodates a 3 ring groove version for containing piston rings. The oil belt is located axially below a pin bore on the pin bosses. The oil belt also has a convex shape extending continuously around a circumference of the piston.

### BACKGROUND OF THE INVENTION

### 1. Technical Field

This invention relates generally to pistons for internal combustion engines, including steel pistons for diesel engines, and methods of manufacturing the pistons.

### 2. Related Art

Steel pistons are typically used in heavy-duty diesel combustion engines. Preferred steel pistons are renowned for robustness and excellent overall performance in functional aspects. However, structural robustness equates to undesirable additional weight and thus higher reciprocating mass. The use of a three-ring package with its inherent high frictional losses is typically used to achieve good oil consumption. The three-ring package causes the piston to be tall (high compression height CH), which also contributes to undesirable packaging volume.

In addition, the steel pistons are oftentimes formed by a forging process which imposes limitations. There are limitations on the piston undercrown architecture, and the initial cost of dies used during the forging process is high. Further, the need for saving weight imposes the use of flat skirt panels perpendicular to the piston pin. Therefore, when the piston is used in the engine, two arch-like unscraped oil film sheets typically adhere to the cylinder liner of the engine and are left at the front and rear of the piston. This oil sheet has to be scraped by an oil ring of the ring belt region of the piston. However, an oil wedge can form beneath the oil ring and hydraulically overpower the oil controlling abilities of the ring, leading to increased oil consumption and carbon build up.

### SUMMARY OF THE INVENTION

One aspect of the invention includes a piston with an oil belt providing improved oil control, and thus reduced oil consumption and build-up of carbon during operation in an internal combustion engine. The piston includes a body formed of an iron-based material. The body includes an upper crown portion presenting a combustion surface for exposure to a combustion chamber. The body also includes a ring belt depending from the combustion surface. The ring belt includes preferentially two ring grooves but can accommodate a more customary 3-ring lay-out. The body also includes pin bosses depending from the ring belt and presenting a pin bore for receiving a pin. The body includes skirt panels depending from the ring belt and located diametrically opposite one another. The pin bosses and said skirt panels together extend continuously around a circumference of the body. The pin bosses and the skirt panels include the oil belt located axially below the pin bore for controlling an oil film and thus achieving the reduced oil consumption and carbon build-up. The oil belt has a convex shape extending continuously around the circumference of the body.

Another aspect of the invention includes a method of manufacturing a piston with an oil belt providing improved oil control, and thus reduced oil consumption and build-up of carbon during operation in an internal combustion engine. The method includes forming a body of an iron-based material. The body includes an uppercrown portion presenting a combustion surface for exposure to a combustion chamber, and a ring belt depending from the combustion surface. The ring belt includes two ring grooves and no more than two ring grooves for containing piston rings. The body also includes pin bosses depending from the ring belt and presenting a pin bore for receiving a pin, and skirt panels depending from the ring belt and located diametrically opposite one another. The pin bosses and the skirt panels include the oil belt located axially below the pin bore, and the oil belt extends circumferentially around the center axis and presents a convex shape.

### BRIEF DESCRIPTION OF THE DRAWINGS

These and other aspects, features and advantages of the invention will become more readily appreciated when considered in connection with the following detailed description and accompanying drawings, in which:

FIG. 1 is a perspective cross-sectional view of a galleryless steel piston according to a first example embodiment of the invention;

FIG. 2 is a bottom view of the galleryless steel piston according to an example embodiment;

FIG. 3 is a bottom view of the galleryless steel piston according to another example embodiment;

FIG. 4 is a bottom view of the galleryless steel piston according to another example embodiment;

FIG. 5 is a perspective cross-sectional view of a gallery-containing piston according to another example embodiment;

FIG. 6 illustrates an insert which can be used to cast a lower portion including pin bosses and skirt sections to an uppercrown portion of the piston according to an example embodiment; and

FIG. 7 illustrates another insert which can be used to cast the lower portion including the pin bosses and the skirt sections to the uppercrown portion of the piston according to another example embodiment which includes a saddle and a ribs along the undercrown surface.

### DETAILED DESCRIPTION OF EXAMPLE EMBODIMENTS

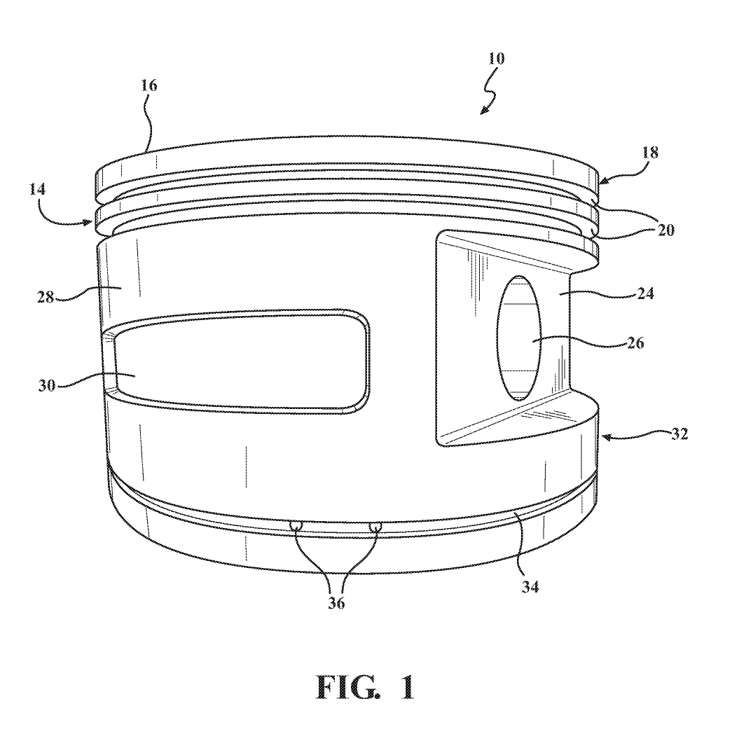

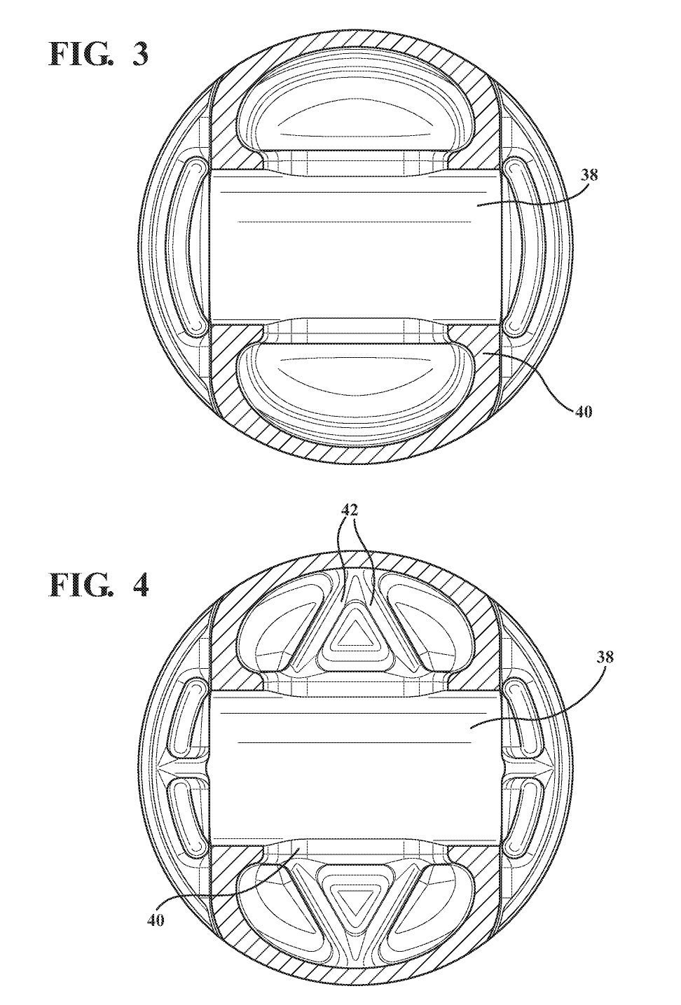

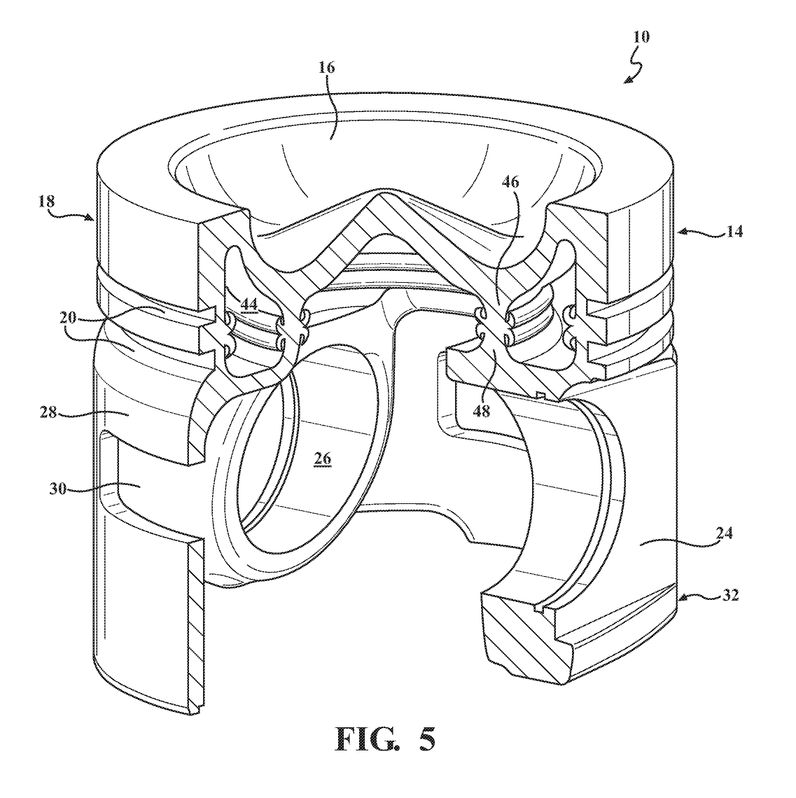

One aspect of the invention provides a piston 10 for an internal combustion engine, such as a heavy-duty diesel engine. The piston aims to prevent oil flooding and thus provides oil control and overpowers the function of a typical oil control ring. According to certain embodiments, the piston has a galleryless design, as shown in FIGS. 1-4. According to other embodiments, the piston contains a closed cooling gallery, as shown in FIG. 5.

In each embodiment, the piston includes a body formed of an iron-based material, such as steel and/or cast iron. The body includes an uppercrown portion 14 presenting a combustion surface 16 for exposure to a combustion chamber of the engine. In the example embodiments, the combustion surface includes a planar area extending around an outer diameter of the body and a combustion bowl extending inwardly from the planar area to a center axis A of the piston. In the example embodiment, the piston includes an apex at the center axis.

The body of the piston further includes a ring belt 18 depending from the combustion surface. The ring belt includes two ring grooves 20 preferentially but can accommodate a more conventional 3 ring lay-out for containing piston rings. For example, the middle compression ring groove of a three-ring groove piston design can be removed, and the third ring groove can be moved upward. In the example embodiment, the ring belt includes a top ring groove disposed adjacent the combustion surface and an oil ring groove disposed adjacent the top ring groove. The oil ring groove is between the top ring groove and pin bosses 24. The top ring groove contains a first ring. According to the example embodiments, the first ring is a keystone, semi-keystone dykes, or L-ring, and the first ring is flush to the planar area of the combustion surface located along the outer diameter of the body. The oil ring groove contains a second ring. The removal of the second ring groove of the three-ring groove design, and the use of a low or zero (ZOT) tension first ring can reduce friction by about 4-6% and provide a savings in fuel consumption (BSFC) of around 1-3%. The reduction in the number of piston ring grooves allows for the removal of material above the pin bosses up to the ring belt, which reduces the weight of the piston compared to pistons with the three-ring groove design.

As shown in the Figures, the pin bosses depend from the ring belt and present a pin bore 26 for receiving a pin. The body also includes skirt sections 28 depending from the ring belt and located diametrically opposite one another. The pin bosses and the skirt sections together extend continuously around a circumference of the body. In the example embodiments, the skirt sections include a curved surface extending from the ring belt region which transition to a flat surface extending to an oil belt on bottom end of the body. In an example embodiment, the longitudinal shaping of the skirt on the Thrust-Non Thrust plane may require a drop in the skirt profile of about 0.085% of the nominal diameter of the body. This is dictated by the excess temperature eventually occurring in connection to the use of sealed-for-life coolants, which use this portion of the piston as a heat sink.

In the example embodiments, each of the skirt sections includes a window 30 where the iron-based material is removed. According to an example embodiment, the windows have the design disclosed in U.S. Pat. No. D645883S. The window of the skirt section typically reduces the area of the skirt section by 20-80% compared to the same skirt section without the window. The windows advantageously reduce the overall weight and hydrodynamic friction of the piston, and the windows provide for heat dissipation. As the piston glides down the stroke, the oil film between the skirt and liner is partially deflected inwards into the undercrown of the piston (wake action). The mist generated lubricates and cools the pin and saddle region. This described action is in addition to the reduction in reciprocating mass provided by the window which, by itself, can also result in a fuel consumption reduction of about 0.5%.

A lower portion of the body of the piston, which includes the skirt panels and pin bosses, is preferably a steel casting. If the lower portion is cast, the windows can be cast in place, and machining can be minimized. If forging is used to form the lower portion of the body, multiaxial forging processes can be used to achieve similar results. Another alternative is to form the lower portion of the body from cast iron.

To reduce or prevent excessive oil film from sticking to a corresponding cylinder liner during use of the piston in an engine, the pin bosses and the skirt panels together include an oil belt 32 for improved oil control during operation of the piston in an engine. As shown in the Figures, the oil belt is located axially below the pin bore and has a convex shape extending continuously around the circumference of the body. According to an example embodiment, the oil belt has an ovality of not greater than 0.10% of a nominal diameter of the body. The diameter of the body of the piston can range from 110 to 160 mm, which is the typical range of diameters of pistons used in a typical class 8 truck. Alternatively, the body can have a diameter larger or smaller than the pistons of typical class 8 trucks.

In addition, the oil belt has a length which is typically not greater than 8% of a length of the body. The length of the body extends from a top end to a bottom end of the body and is parallel to the center axis of the body. The length of the oil belt also extends parallel to the center axis. Preferably, the length of the oil belt is not greater than 10 mm.

During operation, the piston is well guided by the skirt sections in a plane perpendicular to a pin bore axis of the pin bores. However, without the oil belt, the body of the piston could cock forward and backwards appreciably along the pin bore axis, as permitted by a pin to pin boss clearance and production machining tolerances. This reduces the stability of the piston and is highlighted by frequently observed polished areas at top corners of the skirt sections, where the skirt sections blend from a curved to flat profile. This instability transfers to the ring belt and makes controlling the oil film difficult for the oil ring. This is especially true during the down strokes of a comparative piston having a flat area of the skirt panels, during operation, when the oil ring can be faced with an oil film having a thickness of 10 to 15 m (micrometers) radially and sticking to the cylinder liner wall. The oil belt—if properly designed—scrapes and counteracts this excessive oil field. The oil belt is located in a favorable position as its operational temperature can be simulated quite accurately and remain almost constant throughout the cycle and under all engine loads. The oil belt must be designed to aggressively scrape the oil away from the cylinder wall by making the skirt clearance small, for example 0.04-0.06% of piston diameter. The oil belt is preferably circular or has a very low ovality, for example the ovality can be greater than 0.0 and less than 0.10% of the nominal diameter of the body. The scraped oil should be directed to an undercrown region of the piston, thus negating the formation of the so-called “hydraulic wedge/hydraulic wave” and the resultant unstabilizing hydrodynamic pressure (1.0 to 2.5 bar) below the oil ring. The oil belt does not need to be large. A 10 mm axial length or even less is suitable, as are larger lengths. The piston body with the oil belt must also provide for good oil drainage features. This oil belt stabilizes the body in the fore-and-aft plane and avoids the cocking of the body, as mentioned earlier, rendering the reciprocating motion similar to a cross-head piston, i.e., coaxial with the cylinder liner. This is very favorable to ring functional performance, especially with regard to the oil ring and should result in much reduced oil consumption, for example below 0.10 g/kWh.

According to one embodiment, the oil belt may include an oil drain groove 34 and/or features extending circumferentially around said body, as shown in FIG. 1. In addition, a plurality of oil drain slots 36 can be located in the oil drain groove where the material of the body is removed.

The piston also has a reduced compression height (CH) compared to other steel pistons designed for heavy-duty diesel engines. The compression height typically ranges from 40 to 70% of piston diameter. The two-ring groove design provides the opportunity to reduce the compression height. The reduced compression height provides for reduced weight. In addition, a longer connecting rod can be used with the piston, which reduces friction.

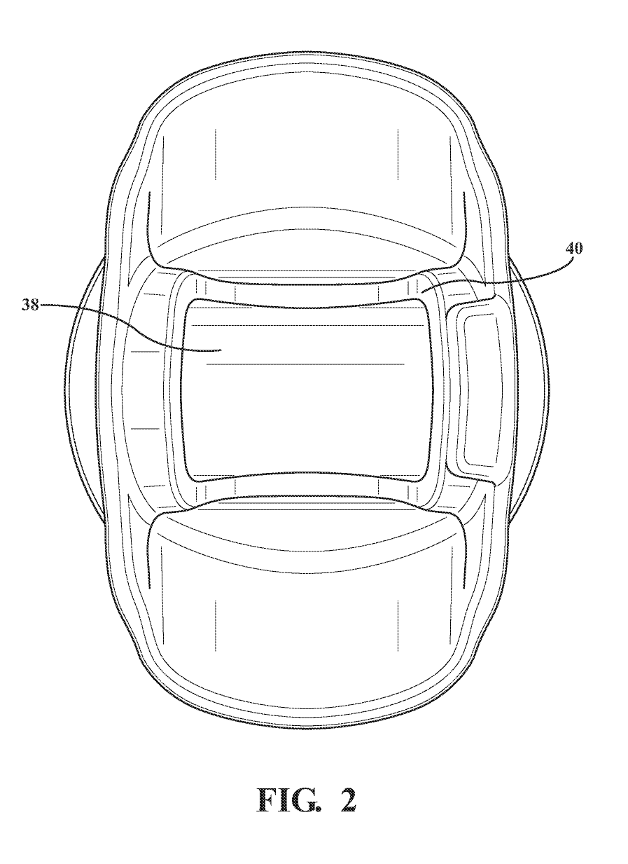

According to the example embodiment shown in FIGS. 1 and 2, the piston has a galleryless design. In this case, the uppercrown portion presents an undercrown surface 38 facing opposite the combustion surface, and the undercrown surface is openly exposed as viewed from an underside of the body of the piston. In the galleryless design, the undercrown surface is not bounded by a sealed or enclosed cooling gallery.

The galleryless design preferentially includes a saddle 40 depending from the undercrown surface, as shown in FIGS. 2-4. The saddle presents an inverted U-shape extending partially around the pin bore axis. The undercrown surface can also include ribs 42 for structural support, as shown in FIG. 4.

According to the example embodiment of FIG. 5, the piston contains a cooling gallery 44. In this case, the uppercrown portion and the lower portion of the body form the cooling gallery therebetween. The uppercrown portion includes an upper inner rib 46 extending circumferentially around the center axis and disposed between the ring belt and the center axis of the body. The lower portion includes a lower inner rib 48 extending circumferentially around the center axis. The lower inner rib is disposed between the lower outer rib and the center axis. The ring belt is joined to the lower outer rib, and the upper inner rib is joined to the lower inner rib. The ring belt, the upper inner rib, the lower inner rib present the cooling gallery therebetween.

Another aspect of the invention provides a method of manufacturing the piston described above. The method includes forming the body of the iron-based material, for example by casting or forging. The casting step can including forming the windows in the skirt sections.

When the casting process is used, it can be difficult to cast a steel uppercrown portion to a cast iron lower portion, which includes the pin bosses and the skirt sections. Friction welding or hybrid induction welding of the uppercrown portion formed of steel to a cast iron lower portion may not have been previously possible. However, brazing techniques are available which have resulted in structurally sound joints between the cast iron lower portion and the steel uppercrown portion. Brazing pastes by the trade names of Bag-4, Braze 403, and Argo-Braze 4ON are examples of products tolerant of temperatures as high as 600° C.

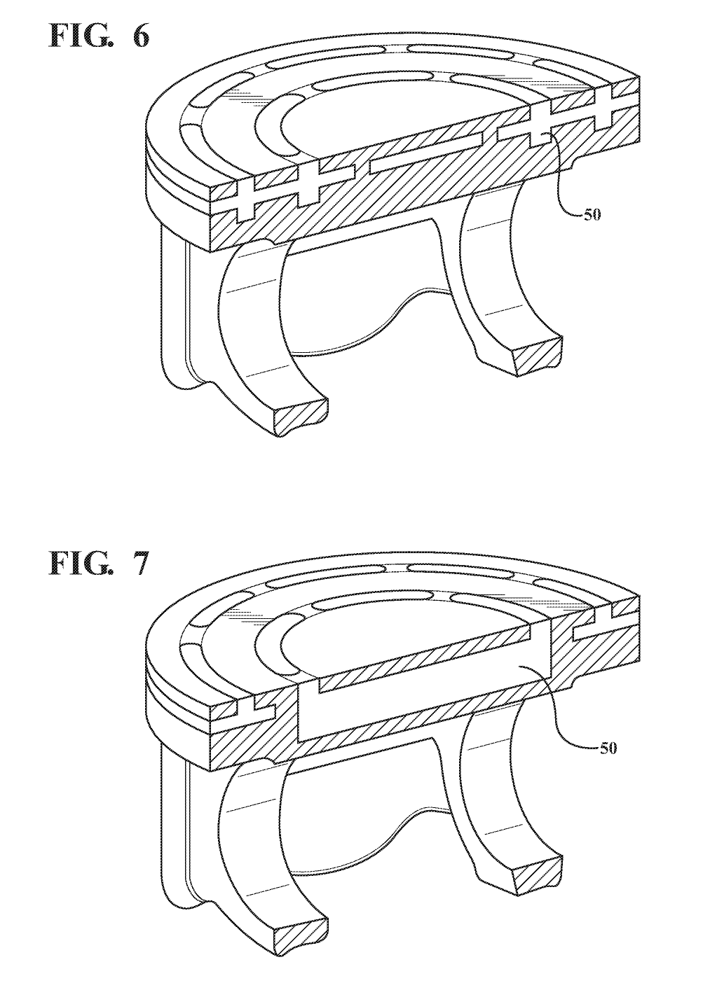

Another option for joining the cast iron lower portion to the steel uppercrown portion can include the use of an insert 50 formed of steel in the cast iron lower portion, as shown in FIGS. 6 and 7. The insert can be integral cast to the lower portion. The steel of the insert can also be cast to the steel of the uppercrown portion. For example, the method can including pre-casting in place a pre-machined insert having a “double cup,” design as shown in FIG. 6, made of the same steel as the uppercrown portion. The double cup design forms the shape of a first cup around the center axis, and the shape of a second cup around the first cup. The steel insert provides the surface to be welded to the steel uppercrown portion. This construction method obviates the inherent incompatibility of cast iron and steel as far as welding is concerned.

Another option is to include the saddle monolithically, as one piece of steel, as shown in FIG. 7, in the piston with the “double cup” insert. The lower portion including the insert and the saddle is also cast to the steel uppercrown portion.

The insert can provide a greater bonding area of the steel of the uppercrown portion to the cast iron of the lower portion. The insert also provides a direct path for combustion gas generated forces to a load-bearing pin which can be used during operation of the piston. This direct path can unload the lower portion of the piston of essentially all the gas pressure forces. The lower portion will have still to carry the inertial loads resultant from reciprocating mass of the piston, besides provide guidance and a heat sink.

Obviously, many modifications and variations of the present invention are possible in light of the above teachings and may be practiced otherwise than as specifically described while within the scope of the invention. It is contemplated that all features described and all embodiments can be combined with each other, so long as such combinations would not contradict one another.

What is claimed is:

1. A piston, comprising:
a body formed of an iron-based material,
said body including an uppercrown portion presenting a combustion surface for exposure to a combustion chamber,
said body including a ring belt depending from said combustion surface,
said ring belt including two ring grooves preferentially but accommodating a 3 ring design capability for containing piston rings,
said body including pin bosses depending from said ring belt and presenting a pin bore for receiving a pin,
said body including skirt panels depending from said ring belt and located diametrically opposite one another,
said pin bosses and said skirt panels together extending continuously around a portion of the circumference of said body,
said pin bosses and said skirt panels including an oil belt located axially below said pin bore, and
said oil belt having a convex shape extending continuously around said circumference of said body.

2. The piston of claim 1, wherein said iron-based material of said body is steel and/or cast iron.

3. The piston of claim 1, wherein each of said skirt sections includes a window where said iron-based material is removed.

4. The piston of claim 1, wherein said oil belt has an ovality of not greater than 0.10% of a nominal diameter of said body.

5. The piston of claim 1, wherein said body has a total length extending from a top end to a bottom end and parallel to a center axis of said body, said oil belt has a length extending parallel to said center axis, and said length of said oil belt is not greater than 8% of said length of said body.

6. The piston of claim 5, wherein said length of said oil belt is not greater than 10 mm.

7. The piston of claim 1, wherein said oil belt includes an oil drain groove and a plurality of oil drain slots in said oil drain groove where said material of said body is removed.

8. The piston of claim 1, wherein said body has a compression height ranging from 40 to 70% of the piston diameter.

9. The piston of claim 1, wherein said ring belt includes a top ring groove disposed adjacent said combustion surface and an oil ring groove disposed adjacent said top ring groove and between said top ring groove and said pin bosses; said top ring groove contains a first ring; said first ring is a keystone, semi-keystone dykes, or L-ring; said first ring is flush to a planar area of said combustion surface located along an outer diameter of said body; and said oil ring groove contains a second ring.

10. The piston of claim 1, wherein said uppercrown portion presents an undercrown surface facing opposite said combustion surface, said undercrown surface is openly exposed as viewed from an underside of said body, and said undercrown surface is not bounded by a sealed or enclosed cooling gallery.

11. The piston of claim 10, wherein said body includes a saddle depending from said undercrown surface, and said saddle presents an inverted U-shape extending partially around said pin bore axis.

12. The piston of claim 1, wherein said body includes a lower portion including said pin bosses and said skirt sections, said uppercrown portion and said lower portion forming a cooling gallery therebetween.

13. The piston of claim 12, wherein said uppercrown portion includes an upper inner rib extending circumferentially around a center axis and disposed between said ring belt and a center axis of said body; said lower portion includes a lower outer rib extending circumferentially around said center axis and radially aligned with said ring belt; said lower portion includes a lower inner rib extending circumferentially around said center axis and disposed between said lower outer rib and said center axis; said ring belt is joined to said lower outer rib and said upper inner rib is joined to said lower inner rib; and said ring belt, said upper inner rib, said lower outer rib, and said lower inner rib present said cooling gallery therebetween.

14. A method of manufacturing a piston, comprising:
forming a body of an iron-based material,
the body including an uppercrown portion presenting a combustion surface for exposure to a combustion chamber,
the body including a ring belt depending from the combustion surface,
the ring belt including two ring grooves and no more than two ring grooves for containing piston rings,
the body including pin bosses depending from the ring belt and presenting a pin bore for receiving a pin,
the body including skirt panels depending from the ring belt and located diametrically opposite one another,
the pin bosses and the skirt panels including an oil belt located axially below the pin bore, and
said oil belt extending circumferentially around the center axis and presenting a convex shape.

15. The method of claim 14, wherein the step of forming the body includes casting.

16. The method of claim 15, wherein the uppercrown portion is formed of steel, the body includes a lower portion including the pin bosses and the skirt sections, the lower portion includes an insert formed of steel, and the steel of the insert is cast to the steel of the uppercrown portion.

17. The method of claim 15, wherein the skirt sections include a window, and the window is formed during the casting step.

18. The method of claim 14 including forging the body.

19. The method of claim 14, wherein the uppercrown portion includes an upper inner rib extending circumferentially around a center axis and disposed between the ring belt and a center axis of the body; the lower portion includes a lower outer rib extending circumferentially around the center axis and radially aligned with the ring belt; the lower portion includes a lower inner rib extending circumferentially around the center axis and disposed between the lower outer rib and the center axis; the ring belt is joined to the lower outer rib and the upper inner rib is joined to the lower inner rib; and the ring belt, the upper inner rib, the lower outer rib, and the lower inner rib present the cooling gallery therebetween.

20. The method of claim 14, wherein the uppercrown portion presents an undercrown surface facing opposite the combustion surface, the undercrown surface is openly exposed as viewed from an underside of the body, and the uppercrown portion is not bounded by a sealed or enclosed cooling gallery.
